(19) United States
(12) Patent Application Publication
(10) Pub. No.: US 2009/0138123 A1
(43) Pub. Date: May 28, 2009

(54) Robotic CBRNE Automated Deployment, Detection, and Reporting System

(75) Inventors: Francesco Pellegrino, Cold Spring Harbor, NY (US); Edward J. Vinciguerra, North Bellmore, NY (US); Nicole Anderson, Broad Run, VA (US); Julie Agboola, Bowie, MD (US); Patrick Boyd, Gainesville, MD (US); Caleb Cammock, Bronx, NY (US); Matthew Caulfield, Wyckoff, NJ (US); Kasey Gust, Westford, ME (US); Patrick Nagurny, Manassas, VA (US); Tetyana Onyshchenko, Charlottesville, VA (US); John-Parker Warren, Coram, NY (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/265,596

(22) Filed: Nov. 5, 2008

Related U.S. Application Data
(60) Provisional application No. 60/985,520, filed on Nov. 5, 2007.

(51) Int. Cl. G05B 15/00

(52) U.S. Cl. 700/259

(57) ABSTRACT

A system having a plurality of networked detectors for detecting chemical, biological, or radiological, nuclear, or explosive agents is disclosed. The system includes a plurality of remote units, wherein each remote unit includes a robotic base, a lift, a sensor module, transceiver, navigation system, and power source. The remote units communicate with a base station, which receives data from the remotes and determines, based on the data, if an alarm condition exists.

### STATEMENT OF RELATED CASES

This case claims priority of U.S. Provisional Patent Application Ser. No. 60/985,520 filed Nov. 5, 2007 and which is incorporated by reference herein.

### FIELD OF THE INVENTION

The present invention relates to homeland security, and more particularly to CBRNE detection systems.

### BACKGROUND OF THE INVENTION

The military has traditionally secured the United States by projecting power overseas. While missions abroad continue to play a vital role for the security of the United States, the terrorist attacks of Sep. 11, 2001 emphasized that the United States is confronting fundamentally different challenges from those faced during the Cold War.

The defining characteristic of the security environment in the near future is the risk of substantial, diverse, and asymmetric challenges to the United States, its allies, and interests. In this context, the United States is faced with great uncertainty regarding the specific character, timing, and sources of potential attacks.

Transnational terrorist groups view the world as an integrated, global battle space in which to exploit perceived U.S. vulnerabilities, wherever they may be. Terrorists seek to attack the United States and its centers of gravity at home and abroad and will use asymmetric means to achieve their ends, such as simultaneous, mass casualty attacks.

To this end, it is foreseeable that adversaries will develop or otherwise obtain chemical, biological, radiological, nuclear, or high-yield explosives (CBRNE) capabilities, with the intent of causing mass panic or catastrophic loss of life. CBRNE detection systems are being developed to protect individuals, assets, and installations from these threats.

In current CBRNE systems, detection equipment is manually deployed and installed by military or civilian personnel along the perimeter of, or within, the area to be protected. This operation exposes these individuals to possible harm by entering areas that may already be contaminated or are otherwise in the line of fire or under adversarial control. Furthermore, in order to obtain confirmation and identification of released biological- or chemical-warfare agents, first responders must wear protective gear to enter monitored zones in order to retrieve potentially hazardous samples.

### SUMMARY OF THE INVENTION

The present invention provides a detection/warning system wherein detectors (e.g., biological, chemical, etc.) are deployed/re-deployed and samples are retrieved without any significant risk of exposure to human operators.

The illustrative embodiment of the present invention is a system of networked detectors on robotic platforms. In some embodiments, the detectors are auto-deployed, monitored, and controlled via wireless communication or fiber links from a central location. In some other embodiments, a remote control is used to individually deploy each robotic platform/detector.

In accordance with the illustrative embodiment, the system includes a plurality of “remote” units and a base station. In some embodiments, each remote includes a robotic base, a transceiver, at least one type of detector (e.g., biological, chemical, etc.) for detecting harmful airborne agents, weather sensors (e.g., wind, humidity, etc.), a lift for elevating the detector to a suitable height, a navigation system, and a power source (e.g., a battery, etc.). The base station collects data from all of the remote units and determines, via a suitably programmed processor, whether an alarm condition exists.

In some embodiments, the remote units include a removable filter (for obtaining an air sample, etc.) and a removable battery module or an otherwise serviceable power source. In such embodiments, the system further includes a “service” remote that is capable of retrieving the filter and/or battery module.

### BRIEF DESCRIPTION OF THE DRAWINGS

FIG. 1 depicts a detection system in accordance with the illustrative embodiment of the present invention.

FIG. 2 depicts a remote detector unit for use in conjunction with the detection system of FIG. 1.

FIG. 3 depicts a workstation for use in conjunction with the detection system of FIG. 1.

FIG. 4 depicts an alternative embodiment of a remote detector unit for use in conjunction with the detection system of FIG. 1.

FIG. 5 depicts a service remote for use in conjunction with the remote unit of FIG. 4.

FIG. 6 depicts a fixture that couples to an arm of the service remote of FIG. 5.

FIGS. 7A and 7B depict a process whereby an arm on the service remote couples to a fixture that attaches to a removable power supply or sample cartridge.

### DETAILED DESCRIPTION

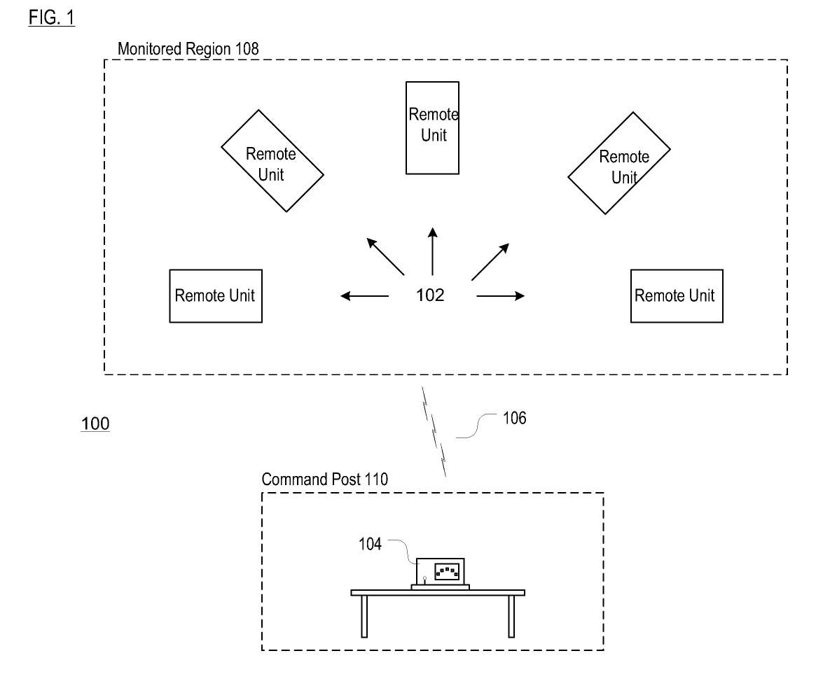

FIG. 1 depicts detection system 100 in accordance with the illustrative embodiment. In the illustrative embodiment, system 100 includes five remote detector units 102 and command and control workstation 104. The detector units are deployed in a region of interest, henceforth, “monitored region 108.” Command and control workstation 104 is typically situated at (mobile) command post 110.

Communications link 106 is established between detectors 102 and workstation 104. In some embodiments of detection system 100, communication between detectors 102 and workstation 104 is one-way, wherein the detector units transmit data to workstation 104. In some other embodiments, communication is two-way, wherein detector units 102 transmit data to workstation 104 and the workstation transmits commands to the detector units. Communications can be either via a wireless link or fiber links.

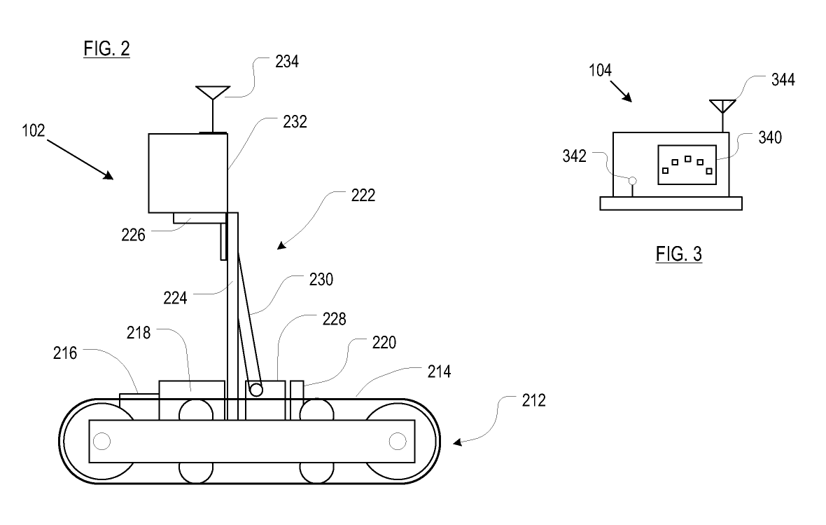

FIG. 2 depicts remote detector unit 102 in accordance with the illustrative embodiment of the present invention. As depicted in FIG. 2, remote unit 102 includes robotic base 212, lift 222, and sensing module 232.

Sensing module 232 is capable of obtaining a sample of air and of performing analytical techniques suitable for obtaining information (e.g., particle counts, fluorescing behavior, etc.) that can be used to determine whether elevated levels of harmful biological, chemical, or radiological agents are present in the sample. In some embodiments, sensing module 232 is further capable of analyzing the ambient environment for a signature indicative of the presence of radiation.

Sensing module 232 further includes weather sensor(s) capable of determining or otherwise obtaining data indicative of one or more meteorological conditions, such as wind speed, wind direction, humidity, and the like.

In some embodiments, sensing module 232 includes a filter or other means suitable for capturing and storing a sample for later analysis at command post 110 or elsewhere.

Robotic base 212 is the means by which sensing module 232 is remotely deployed. In some embodiments, robotic base 212 deploys to an intended site by responding to commands being transmitted from workstation 104. In other cases, the robotic base is pre-programmed to follow a specific route.

Robotic base 212 includes left and right treads 214 for locomotion (only one of the treads is visible in FIG. 2. Treads 214 are individually controllable to facilitate steering. In some other embodiments, robotic base 212 includes a plurality of wheels/tires, rather than treads. In some of these embodiments, at least one wheel/tire on each side of robotic base 212 is at least partially rotatable for steering. In some other embodiments, robotic base 212 is “steered” by independently controlling the rotation speed of the wheels/tires on each side of the robotic base.

Robotic base 212 is driven and controlled by a drive/control system, shown generally at 216. The drive/control system includes a motor and gearing, etc., suitable for driving robotic base 212. Drive/control system 216 also includes a controller for controlling the drive motor, responsive to commands from navigation system 220.

Navigation system 220 supports the deployment operation of remote unit 102. In some embodiments, navigation system 220 comprises equipment suitable for directing drive/control system 216 to execute commands that are received from workstation 104. In some of these embodiments, navigation system 220 also includes a camera (e.g., video, etc.), for obtaining images of the environs of remote 102. The images are transmitted via communications link 106 to workstation 104. A human operator uses the incoming video to assist in remotely steering remote unit 102.

In some other embodiments, navigation system 220 comprises a GPS receiver, which enables remote unit 102 to determine its location. Location information is transmitted to workstation 104 via communications link 106. The location information is then used to guide remote detector unit 102 to its intended location.

In some additional embodiments, navigation system 220 includes a GPS receiver and map data, etc., so that remote unit 102 can autonomously navigate to its intended site. In such embodiments, navigation system includes obstacle avoidance software.

Lift 222 is used to position sensing module 232 at an appropriate height for operations (i.e., sampling the ambient air, locomotion, etc.). Lift 222 includes upright frame 224, vertically-movable platform 226, lift drive/control system 228, and chain/belt 230. Sensing module 232 is disposed on vertically-movable platform 226. During deployment, platform 226 and sensing module 232 are lowered for stability and to avoid undue stresses on lift 222. Once remote unit 102 has reached its intended location, platform 226 raises sensing module 232 to facilitate sensing operations. In some embodiments, lift 222 is remotely controlled from workstation 104. In some other embodiments, operation of lift 222 is pre-programmed.

Remote unit 102 includes appropriate communications equipment (e.g., radio, transmitter, antenna, etc.), shown generally at 234, for establishing communications link 106 with workstation 104.

Drive/control system 216 and lift 222 are powered by one or more power supplies 218, typically a battery, batteries and solar panels, etc. Power supply 218 will advantageously provide enough power for one hour of driving and at least twenty-four hours of stationary operation (powering at least sensing module 232 and communications equipment 234).

Referring now to FIG. 3, workstation 104 includes a suitably programmed processor (not depicted) for analyzing incoming data from remotes 102 to determine whether an alarm condition exists. Depending upon the nature of the processing required, some of the data can be forwarded to a headquarters location for more computationally-intensive analysis. The workstation includes display 340 for showing the location of remote units 102. In embodiments in which workstation is used to control remotes 102, the workstation includes control stick 342. Workstation 104 also includes (or otherwise communicates with) appropriate communications equipment (e.g., radio, transmitter, antenna, etc.), shown generally at 344, for establishing communications link 106 in conjunction with communications equipment on remotes 102.

Once remote units 102 are deployed, sensing module 232 obtains air samples and conducts appropriate tests. In some embodiments, data obtained by sensing module 232 is transmitted to workstation 104 for analysis. Data from each remote is analyzed and, based on the results of the analyses, a determination is made as to whether or not a harmful agent is present at abnormal levels. The determination is communicated to the workstation operator and appropriately disseminated.

The communications link is also used to transmit, from remote unit 102 to workstation 104, meteorological data and data concerning the health/status of the systems on the remote (e.g., battery power reserve, tire pressure, etc.).

The concept of operations for remote units 102 is to deploy to an intended location and monitor the air for a period of time. After an appropriate period of monitoring (e.g., 24 hours, etc.), the remote units return to command post 110.

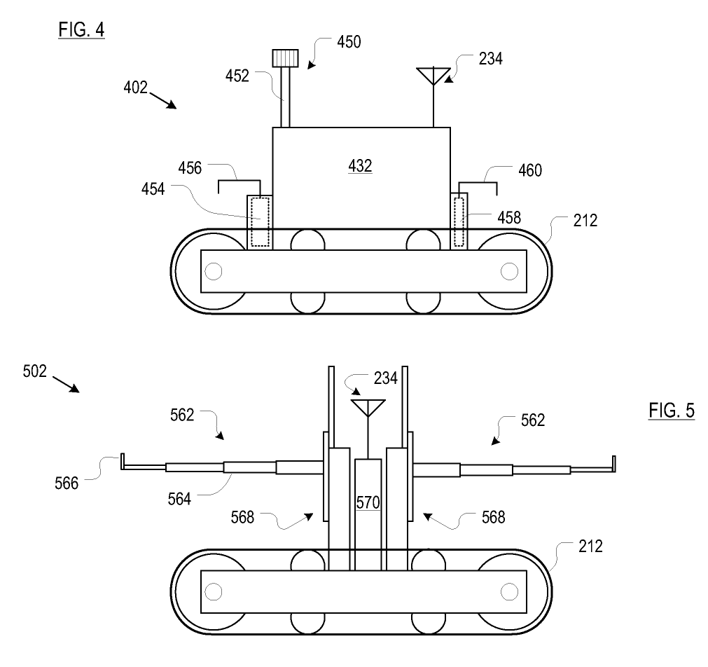

FIG. 4 depicts an alternative embodiment of a remote detector unit and FIG. 5 depicts a service remote for use with the remote unit of FIG. 4.

Referring now to FIG. 4, remote detector unit 402 includes robotic base 212, sensing module 432, sampling port 450, removable power supply 454, and removable sample cartridge 458.

Robotic base 212 is the same robotic base as used for remote detector unit 102. It has the same capabilities and includes the same drive, control, and navigation elements (not shown in FIG. 4).

Sensing module 432 has the same sensing capabilities of sensing module 232. Remote unit 402 does not include a lift. As a consequence, sensing module 432 include a sampling port 450 that extends vertically from the body of the sensing module to an appropriate height for air sampling (at least about six feet above the ground). In some embodiments, the height of the sampling port is vertically adjustable via extendable neck 452. In some other embodiments, the neck is not height-adjustable.

Remote detector unit 402 is intended to remain in the field for longer periods of time than remote unit 102. As a consequence, provisions for replacing the power supply and retrieving samples are necessary. To that end, remote unit 402 includes removable power supply (e.g., battery, etc.) 454 and removable sample cartridge 458.

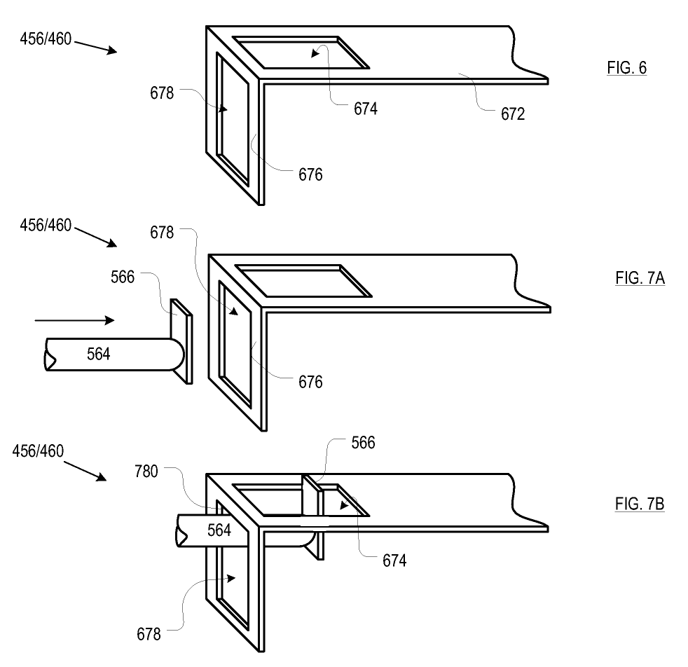

To facilitate robotic removal of power supply 454 and sample cartridge 458, both include a removal fixture. In particular, depending from the removable power supply and the removable sampling cartridge are respective fixtures 456 and 460. Further detail of fixtures 456 and 460 is provided in conjunction with FIGS. 6, 7A, and 7B.

FIG. 5 depicts service remote 502 for use with remote unit 402. The service remote is capable of being deployed to remote detector units 402 that are in the field to (1) remove power supply 454 and insert a replacement power supply and (2) remove sample cartridge 458 and insert a replacement sample cartridge. Removed sample cartridge 458 is then returned to the command post for additional analysis.

In the embodiment that is depicted in FIG. 5, service remote 502 includes robotic base 212, two arms 562 and two lifts 568.

Each arm includes telescoping portion 564 and capture tab 566. The telescoping portion is retractable (such as for when unit 402 is moving) and extendable to for retrieval/replacement operations. Using lifts 568, the height of arms 562 can be adjusted. For example, the arm is adjusted to a first height for coupling to fixture 456 or 460 of detector unit 402. To remove the battery or sampling cartridge from remote unit 402, the arm is raised to a second height. The arm might be adjusted to a third height (and retracted) for return to command center 110. The arms and lifts are driven by motors, which are not depicted.

Service remote 502 includes various controllers, etc., indicated generally at 570, for controlling the motors that control arms 562 and lifts 568.

FIG. 6 depicts fixture 456 (or 460). As depicted, fixture 456 (460) includes horizontally-oriented member 672 and vertically-oriented member 676. Horizontally-oriented member 672 includes opening 674. Vertically-oriented member 676 includes opening 678. In the present embodiment, openings 674 and 678 receive the end of one of the arms 562 during the process of removal/insertion of a power supply or sample cartridge.

FIGS. 7A and 7B depict the engagement process whereby arm 562 couples to fixture 456 (460). FIG. 7A depicts the distal end of one of arms 562 approaching opening 678 in vertically-oriented member 676. Opening 678 is sufficiently large to permit capture tab 566, which depends from the distal-most segment 564 of arm 562, to pass.

FIG. 7B depicts arm 562 fully engaged to fixture 456 (460). After capture tab 566 clears opening 678 and is positioned under opening 674 in horizontally-oriented member 672, arm 562 is raised slightly so that the segment 564 abuts uppermost opening-defining edge 780 of opening 678. As a result, capture tab 566 extends through opening 674.

To complete the process of removing power supply 454 or sample cartridge 458, lift 568 raises arm 562 further to withdraw the power supply or sample cartridge from its dock, etc. Capture tab 566 will prevent arm 562 from decoupling from fixture 456 (460) until the power supply or sample cartridge from which the fixture depends is lowered to a surface such that segment 564 drops away from edge 780 and that segment and capture tab 566.

As an alternative to the foregoing embodiment, in some embodiments, a grasping mechanism is disposed at the distal end of arm 562. In such embodiments, fixtures 456 and 460 are suitable modified to facilitate capture via the grasping mechanism. In still further embodiments, an electromagnetic is disposed at the end of arm 562 for retrieving removable battery 454 or removable sample cartridge 458. Again, fixtures 456 and 460 are suitably modified to accommodate the change to the retrieval means.

The two arms 562 of service remote 502 can be utilized as follows. After receiving a transmission from one of remote detector units 402 that its battery is getting low on charge, a replacement battery can be coupled to one of the arms (e.g., as per FIG. 7B). Once the service remote reaches remote unit 402, the unencumbered arm 562 is used to withdraw the power supply 454. Once the power supply is removed, service remote 502 repositions itself to deliver the replacement power supply carried by the other arm 562.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An automated deployment, detection, and report system, comprising:
a workstation; and
a plurality of remote detector units, wherein the remote detector units are in communication with the workstation, and wherein each remote detector unit comprises:
a robotic base that enables the remote detector unit to move;
a sensor module operable to obtain a sample of air and perform analyses on the sample, wherein the analyses provides information related to the concentration of at least one of chemical agents, biological agents, and radiological agents in the sample;
communications equipment for communicating with a workstation, wherein the communications equipment transmits the information to the workstation;
a navigation system for enabling the remote detector unit to deploy to an intended site; and
a power source for powering the robotic base, the sensor module, the communications equipment and the navigation system.

2. The system of claim 1 wherein the sensor module is operable to obtain meteorological data.

3. The system of claim 1 wherein the navigation system comprises a video camera.

4. The system of claim 1 wherein the navigation system comprises a GPS receiver.

5. The system of claim 1 wherein the navigation system is operable to autonomously navigate to the intended site.

6. The system of claim 1 wherein the workstation includes a remote control for controlling the movement of remote detector unit.

7. The system of claim 1 wherein the workstation is capable of receiving a signal from the video camera.

8. The system of claim 1 wherein the sensor module is capable of retaining a sample selected from the group consisting of a sample of air, a chemical agent contained in air sampled by the sensor module, or a biological agent contained in air sampled by the sensor module.

9. The system of claim 1 further comprising a lift having a height-adjustable platform, wherein the sensor module is disposed on the platform.

10. The system of claim 1 wherein the power source is removable and replaceable.

11. The system of claim 8 further comprising a removable sample cartridge for retaining the sample.

12. The system of claim 10 further comprising a service remote, wherein the service remote is physically adapted to remove the removable power source from the remote detector unit.

13. The system of claim 10 further comprising a service remote, wherein the service remote is physically adapted to install a replacement power source on the remote detector unit.

14. The system of claim 11 further comprising a service remote, wherein the service remote is physically adapted to remove the removable sample cartridge from the remote detector unit.

15. The system of claim 11 further comprising a service remote, wherein the service remote is physically adapted to install a replacement sample cartridge on the remote detector unit.
